(19) United States
(12) Patent Application Publication
(10) Pub. No.: US 2018/0138957 A1
(43) Pub. Date: May 17, 2018

(54) DATA TRANSMISSION METHOD, REMOTE RADIO UNIT RRU, AND BASEBAND UNIT BBU

(71) Applicant: HUAWEI TECHNOLOGIES CO., LTD., Shenzhen (CN)

(72) Inventors: Jueping WANG, Shanghai (CN); Wei YE, Beijing (CN); Si ZHANG, Shenzhen (CN)

(73) Assignee: HUAWEI TECHNOLOGIES CO., LTD., Shenzhen (CN)

(21) Appl. No.: 15/870,154

(22) Filed: Jan. 12, 2018

Related U.S. Application Data
(63) Continuation of application No. PCT/CN2015/098110, filed on Dec. 21, 2015.

(51) Int. Cl. H04B 7/06; H04W 72/04

(52) U.S. Cl. CPC H04B 7/0615; H04W 72/04

(57) ABSTRACT

The present invention provides a data transmission method, a remote radio unit RRU, and a baseband unit BBU. The method includes: receiving, by the RRU, stream data sent by the BBU, where the stream data is obtained after the BBU performs resource mapping processing on to-be-transmitted downlink data; performing, by the RRU, stream to antenna mapping processing on the stream data; and sending, by the RRU, mapping-processed data to user equipment by using an antenna. In the data transmission method of embodiments of the present invention, service stream data is transmitted between the BBU and the RRU. This can reduce data traffic between the BBU and the RRU, so as to reduce fronthaul data bandwidth between the BBU and the RRU.

### CROSS-REFERENCE TO RELATED APPLICATIONS

This application is a continuation of International Application No. PCT/CN2015/098110, filed on Dec. 21, 2015, which is hereby incorporated by reference in its entirety.

### TECHNICAL FIELD

Embodiments of the present invention relate to the communications field, and more specifically, to a data transmission method, a remote radio unit RRU, and a baseband unit BBU.

### BACKGROUND

In an existing wireless cellular communications system, a distributed base station is one of main deployment forms currently. In the distributed base station, a remote radio unit (Remote Radio Unit, “RRU” for short) and a baseband unit (Baseband Unit, “BBU” for shot) are generally interconnected by using a cable, to implement a common public radio interface (Common Public Radio Interface, “CPRI” for short) signal connection.

Currently, the BBU is responsible for functions of basebands including a layer 1 (Layer 1, “L1” for short), a layer 2 (Layer 2, “L2” for short), and a layer 3 (Layer 3, “L3” for short). The RRU is mainly responsible for radio frequency transceiver functions including radio frequency transmitting/receiving (TRX) and power amplification (Power Amplifier, “PA” for short).

In a downlink direction, after completing functions of fast Fourier transformation (Fast Fourier Transformation, “FFT” for short) and inserting a cyclic prefix (Cyclic Prefix, “CP” for short), the baseband L1 of the BBU transmits, by using a CPRI interface, IQ data of L1 to the RRU for processing. In an uplink direction, after receiving data from the RRU, the baseband L1 of the BBU first removes a CP, then performs fast Fourier transformation (Fast Fourier Transformation, “FFT” for short), and then completes other data processing.

As a large-scale antenna array is widely applied, fronthaul data traffic between the BBU and the RRU is increasingly large, and accordingly, deployment difficulty and costs increase. Further, in a scenario in which the RRU and the BBU are remotely connected, the deployment difficulty and costs are greater. Therefore, data traffic between the BBU and the RRU needs to be reduced.

### SUMMARY

Embodiments of the present invention provide a data transmission method, a remote radio unit RRU, and a baseband unit BBU. This can reduce data traffic between the BBU and the RRU, so as to reduce fronthaul data bandwidth between the BBU and the RRU.

A first aspect provides a data transmission method, where the method is applied to a base station, the base station includes a baseband unit BBU and a remote radio unit RRU, and the method includes: receiving, by the RRU, stream data sent by the BBU, where the stream data is obtained after the BBU performs resource mapping processing on to-be-transmitted downlink data; performing, by the RRU, stream to antenna mapping processing on the stream data; and sending, by the RRU, mapping-processed data to user equipment by using an antenna.

With reference to the first aspect, in an implementation manner of the first aspect, the sending, by the RRU, mapping-processed data to user equipment by using an antenna includes: performing, by the RRU, inverse fast Fourier transformation IFFT processing and cyclic prefix CP insertion processing on the mapping-processed data, to obtain downlink data; and sending, by the RRU, the downlink data to the user equipment by using the antenna.

With reference to the first aspect and the foregoing implementation manner of the first aspect, in another implementation manner of the first aspect, the method further includes: receiving, by the RRU, a downlink dynamic antenna weighted value sent by the BBU; and the performing, by the RRU, stream to antenna mapping processing on the stream data includes: performing, by the RRU, the stream to antenna mapping processing on the stream data according to the downlink dynamic antenna weighted value.

With reference to the first aspect and the foregoing implementation manners of the first aspect, in another implementation manner of the first aspect, the method further includes: performing, by the RRU, antenna to beam mapping processing on data of the user equipment; and sending, by the RRU, mapping-processed data to the BBU.

With reference to the first aspect and the foregoing implementation manners of the first aspect, in another implementation manner of the first aspect, the method further includes: receiving, by the RRU by using the antenna, an uplink signal sent by the user equipment, where the uplink signal includes the data and a sounding reference signal SRS; separating, by the RRU, the SRS and the data from the uplink signal; and sending, by the RRU, the SRS to the BBU.

With reference to the first aspect and the foregoing implementation manners of the first aspect, in another implementation manner of the first aspect, the separating, by the RRU, the SRS and the data from the uplink signal includes: performing, by the RRU, fast Fourier transformation FFT processing and cyclic prefix CP removing processing on the uplink signal, to obtain a frequency domain signal; and the separating, by the RRU, the SRS and the data from the uplink signal includes: separating, by the RRU, the SRS and the data from the frequency domain signal.

With reference to the first aspect and the foregoing implementation manners of the first aspect, in another implementation manner of the first aspect, the data includes non-spatial multiplexing data and spatial multiplexing data; and the performing, by the RRU, antenna to beam mapping processing on data of the user equipment includes: receiving an uplink dynamic antenna weighted value sent by the BBU; performing antenna to beam mapping processing on the spatial multiplexing data according to the uplink dynamic antenna weighted value; and performing antenna to beam mapping processing on the non-spatial multiplexing data according to an uplink static antenna weighted value.

A second aspect provides a data transmission method, where the method is applied to a base station, the base station includes a baseband unit BBU and a remote radio unit RRU, and the method includes: performing, by the BBU, resource mapping processing on to-be-transmitted downlink data to obtain stream data; and sending, by the BBU, the stream data to the RRU, so that the RRU performs stream to antenna mapping processing on the stream data, and sends mapping-processed data to user equipment by using an antenna.

With reference to the second aspect, in an implementation manner of the second aspect, the method further includes: determining, by the BBU, a downlink dynamic antenna weighted value; and sending, by the BBU, the downlink dynamic antenna weighted value to the RRU, so that the RRU performs the stream to antenna mapping processing on the stream data according to the downlink dynamic antenna weighted value.

With reference to the second aspect and the foregoing implementation manner of the second aspect, in another implementation manner of the second aspect, the method includes: receiving, by the BBU, data sent by the RRU, where the data is obtained after the RRU performs antenna to beam mapping processing on data of the user equipment; and processing, by the BBU, the data to obtain uplink data.

With reference to the second aspect and the foregoing implementation manners of the second aspect, in another implementation manner of the second aspect, the method further includes: receiving, by the BBU, a sounding reference signal SRS sent by the RRU.

With reference to the second aspect and the foregoing implementation manners of the second aspect, in another implementation manner of the second aspect, the processing, by the BBU, the data to obtain uplink data includes: obtaining, by the BBU, frequency domain data after performing Fourier transformation FFT processing and cyclic prefix CP removing processing on the data; and processing, by the BBU, the frequency domain data to obtain the uplink data.

With reference to the second aspect and the foregoing implementation manners of the second aspect, in another implementation manner of the second aspect, the data includes non-spatial multiplexing data and spatial multiplexing data, and the method further includes: determining, by the BBU, an uplink dynamic antenna weighted value, and sending, by the BBU, the uplink dynamic antenna weighted value to the RRU, so that the RRU performs antenna to beam mapping processing on the spatial multiplexing data according to the uplink dynamic antenna weighted value.

A third aspect provides a baseband unit BBU, configured to execute the method in the foregoing first aspect or any possible implementation manner of the first aspect. Specifically, the BBU includes a module configured to execute the method in the foregoing first aspect or any possible implementation manner of the first aspect.

A fourth aspect provides a remote radio unit RRU, configured to execute the method in the foregoing second aspect or any possible implementation manner of the second aspect. Specifically, the RRU includes a module configured to execute the method in the foregoing second aspect or any possible implementation manner of the second aspect.

A fifth aspect provides a computer readable medium, configured to store a computer program, and the computer program includes an instruction used for executing the method in the first aspect or any possible implementation manner of the first aspect.

A sixth aspect provides a computer readable medium, configured to store a computer program, and the computer program includes an instruction used for executing the method in the second aspect or any possible implementation manner of the second aspect.

A seventh aspect provides a computer program product, and the computer program product includes computer program code. The computer program code is run by an RRU, so that the RRU executes the method in the foregoing first aspect or any possible implementation manner of the first aspect.

An eighth aspect provides a computer program product, and the computer program product includes computer program code. The computer program code is run by a BBU, so that the BBU executes the method in the foregoing second aspect or any possible implementation manner of the second aspect.

### BRIEF DESCRIPTION OF DRAWINGS

FIG. 1 is an architecture diagram of a distributed base station in the prior art;

FIG. 2 is a schematic diagram of function distribution of a BBU and an RRU in the prior art;

FIG. 3 is a schematic flowchart of a data transmission method according to an embodiment of the present invention;

FIG. 4 is a schematic diagram of a data transmission method according to a specific embodiment of the present invention;

FIG. 5A and FIG. 5B are a schematic diagram of a data transmission method according to another specific embodiment of the present invention;

FIG. 6A, FIG. 6B, and FIG. 6C are a schematic diagram of a data transmission method according to still another specific embodiment of the present invention;

FIG. 7 is a schematic block diagram of an RRU according to an embodiment of the present invention;

FIG. 8 is a schematic block diagram of a BBU according to an embodiment of the present invention;

FIG. 9 is another schematic block diagram of a BBU according to an embodiment of the present invention;

FIG. 10 is a schematic block diagram of an RRU according to another embodiment of the present invention; and

FIG. 11 is a schematic block diagram of a BBU according to another embodiment of the present invention.

### DESCRIPTION OF EMBODIMENTS

Technical solutions of embodiments of the present invention may be applied to various communications systems, such as a Global System for Mobile Communications (Global System of Mobile Communication, “GSM” for short) system, a Code Division Multiple Access (Code Division Multiple Access, “CDMA” for short) system, a Wideband Code Division Multiple Access (Wideband Code Division Multiple Access, “WCDMA” for short) system, a Long Term Evolution (Long Term Evolution, “LTE” for short) system, an LTE frequency division duplex (Frequency Division Duplex, “FDD” for short) system, an LTE time division duplex (Time Division Duplex, “TDD” for short) system, a Universal Mobile Telecommunications System (Universal Mobile Telecommunication System, “UMTS” for short), and a future 5G communications system.

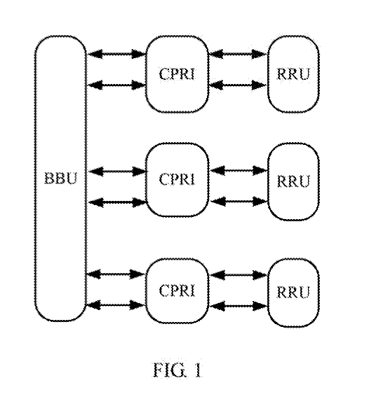

FIG. 1 is an architecture diagram of a distributed base station in the prior art. As shown in FIG. 1, the distributed base station includes a baseband unit (Baseband Unit, “BBU” for short) and a remote radio unit (Remote Radio Unit, “RRU” for short), and baseband data is transmitted between the BBU and the RRU by using a common public radio interface (Common Public Radio Interface, “CPRI” for short). Generally, BBUs are centrally deployed in an equipment room. RRUs are deployed at a remote end, and one BBU may be connected to multiple RRUs.

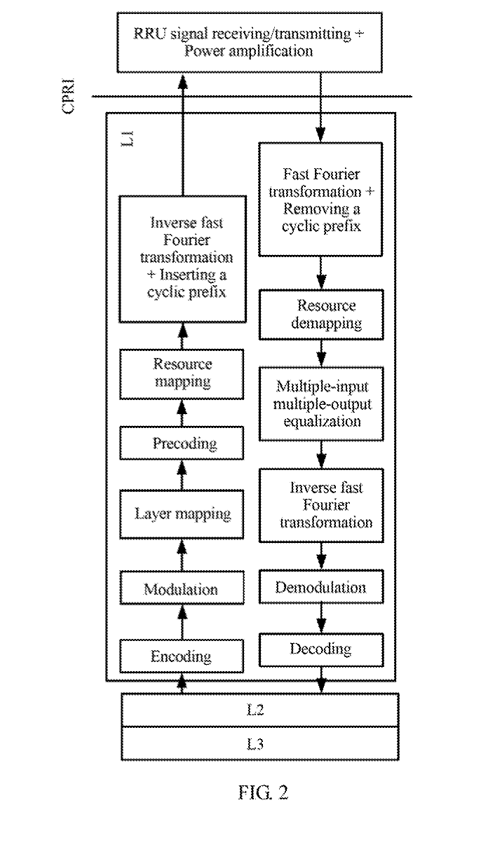

FIG. 2 shows specific functions of a BBU and an RRU in the prior art. As shown in FIG. 2, the BBU is responsible for functions of basebands including a layer 1 (Layer 1, “L1” for short), a layer 2 (Layer 2, “L2” for short), and a layer 3 (Layer 3, “L3” for short). Downlink functions of the baseband L1 mainly include: encoding (Encoder), modulation (Modulation), layer mapping (Layer Mapping), precoding (Precording), resource mapping (Resource Element Mapping), inverse fast Fourier transformation (Inverse Fast Fourier Transformation, “IFFT” for short), and inserting a cyclic prefix (Cyclic Prefix, “CP” for short). Uplink functions of the baseband L include fast Fourier transformation (Fast Fourier Transformation, “FFT” for short), removing a CP, resource demapping (Resource Element Demapping), multiple-input multiple-output (Multiple-Input Multiple-Output, “MIMO” for short), equalization (Equalizer), IFFT, demodulation (Demodulation), and decoding (Decoder). With wide application of a large-scale antenna array, fronthaul data traffic between the BBU and the RRU is increasingly large, and accordingly, deployment difficulty and costs increase.

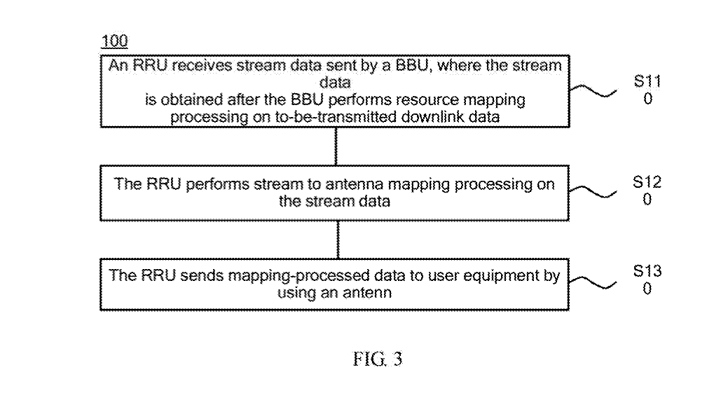

FIG. 3 shows a schematic flowchart of a data transmission method according to an embodiment of the present invention. The method is applied to a base station, and the base station includes a baseband unit BBU and a remote radio unit RRU. As shown in FIG. 3, the method 100 includes the following content:

S110. The RRU receives stream data sent by the BBU, where the stream data is obtained after the BBU performs resource mapping processing on to-be-transmitted downlink data.

S120. The RRU performs stream to antenna mapping processing on the stream data.

S130. The RRU sends mapping-processed data to user equipment by using an antenna.

In the data transmission method of this embodiment of the present invention, an RRU performs stream to antenna mapping processing in a downlink, and therefore service stream data is transmitted between a BBU and the RRU. This can reduce data traffic between the BBU and the RRU, so as to reduce fronthaul data bandwidth between the BBU and the RRU.

The method in this embodiment of the present invention may be applied to the following two scenarios. (I) Non-MIMO (in other words, transmission mode (Transmission mode, “TM” for short) 2, or TM3) scenario: In this scenario, data output after the BBU performs precoding processing is antenna data, and when performing the stream to antenna mapping (Stream to Antenna Mapping) processing on the stream data, the RRU does not change the stream data in any form, that is, the stream to antenna mapping processing is transmitting data transparently without mapping. (II) MIMO (in other words, TM4 to TM9) scenario: In this scenario, the RRU completes a precoding function when performing the stream to antenna mapping processing.

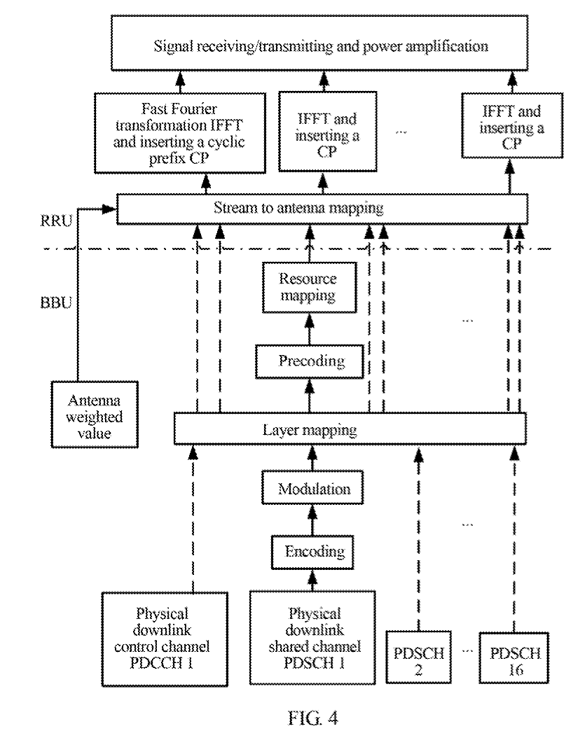

In a downlink, as shown in FIG. 4, a BBU may obtain stream data after successively performing encoder, modulation, layer mapping, and resource element mapping processing on physical downlink control channel (Physical Downlink Control Channel, “PDCCH” for short) data and physical downlink shared channel (Physical Downlink Shared Channel, “PDSCH” for short) data, and then sends the stream data to an RRU by using an interface between the BBU and the RRU. Accordingly, the RRU performs stream to antenna mapping processing on the stream data after receiving the stream data, and sends mapping-processed data to user equipment by using an antenna.

In this embodiment of the present invention, optionally, when the RRU sends the mapping-processed data to the user equipment by using the antenna, as shown in FIG. 4, the RRU performs inverse fast Fourier transformation IFFT processing and cyclic prefix CP insertion processing on the mapping-processed data, to obtain downlink data, and then sends the downlink data to the user equipment by using the antenna. In addition, the RRU may perform power amplification processing on the downlink data before sending the downlink data.

Before the RRU performs the stream to antenna mapping processing, the RRU may receive a downlink dynamic antenna weighted value sent by the BBU, and when performing the stream to antenna mapping processing, the RRU performs the processing according to the received downlink dynamic antenna weighted value. The downlink dynamic antenna weighted value may also be referred to as an “L1 antenna weighted value” or an “L1 weighted value”, and the protection scope of the present invention is not limited to the name.

In an example, a process of performing the stream to antenna mapping processing by the RRU may be expressed as:

Y=WX (1)

Y indicates data obtained after the stream to antenna mapping processing, and may be referred to as “physical antenna data”; X is stream data before the mapping processing, W indicates a downlink dynamic antenna weighted value for the stream to antenna mapping, and Y, X, and W may be respectively expressed as:

$$Y = [ \begin{matrix}{y}_{1} \\ {y}_{2} \\ ⋮ \\ {y}_{m}\end{matrix} ] ,$$

where m is a quantity of physical antennas;

$$X = [ \begin{matrix}{x}_{1} \\ {x}_{2} \\ ⋮ \\ {x}_{n}\end{matrix} ] ,$$

where
n is a quantity of streams; and

$$W = [ \begin{matrix}{w}_{11} & … & {w}_{1 n} \\ ⋮ & ⋱ & ⋮ \\ {w}_{m 1} & … & {w}_{mn}\end{matrix} ] .$$

For example, in FIG. 4, after precoding, a PDCCH occupies two streams (Stream), a PDSCH occupies 16 streams, and therefore there are a total of 18 data streams between the BBU and the RRU. In addition, data traffic between the BBU and the RRU may be calculated according to the following manner:

Data traffic=N(quantity of data streams or referred to as a quantity of virtual antennas)×1200(quantity of subcarriers)×bit width(I and Q sampling bandwidth)/72 us(symbol duration); and

data traffic of an antenna weighted value=100(quantity of resource blocks(Resource Block, “RB” for short))×M(quantity of physical antennas)×32 bit(sampling bit width of an L1 antenna weighted value)×N/1 ms.

In addition, there may be the following control or scheduling information: information used to indicate that an overhead of user uplink/downlink RB allocation information is 1 byte/RB/millisecond; information used to indicate that an overhead of uplink/downlink channel antenna configuration information is 2 bytes/RB/millisecond; information used to indicate that an extra overhead brought by a packet assembly of scheduling and configuration information is 1 byte/RB/millisecond; and information used to indicate that required bandwidth is about (RB allocation information byte (1 byte)+antenna configuration information byte (1 byte)+scheduling and configuration information byte (0.5 bytes))×quantity of RBs (100)×byte bit width (8 bit)/1 ms.

Optionally, in an uplink, the RRU performs antenna to stream mapping processing on data of the user equipment, and then sends mapping-processed data to the BBU.

In the data transmission method of this embodiment of the present invention, an RRU completes antenna to stream mapping processing, and therefore service stream data is transmitted between a BBU and the RRU. This can reduce data traffic between the BBU and the RRU, so as to reduce fronthaul data bandwidth between the BBU and the RRU.

Specifically, the RRU receives, by using the antenna, an uplink signal sent by the user equipment, where the uplink signal includes the data and a sounding reference signal (Sounding Reference Signal, “SRS” for short), separates the SRS and the data from the uplink signal, and sends the SRS to the BBU.

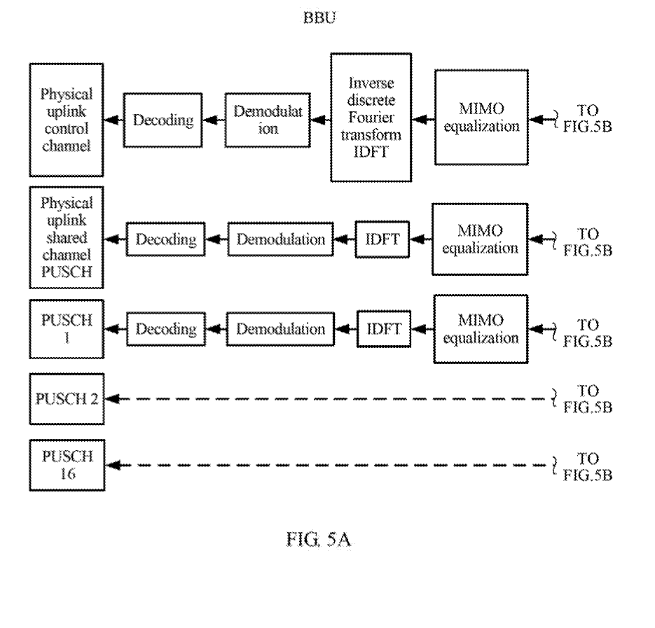

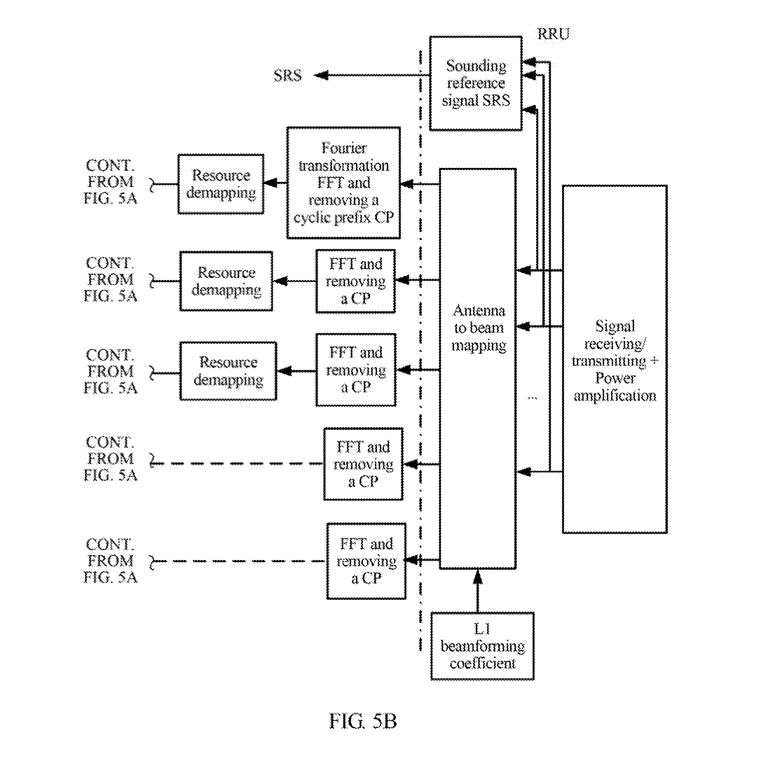

FIG. 5A and FIG. 5B show a data transmission method according to another specific embodiment of the present invention. In FIG. 5A and FIG. 5B, an RRU receives uplink data of user equipment, and separates, in a time domain, an SRS from data received by each physical antenna. Then, the SRS is separately transmitted to a BBU. Corresponding to FIG. 4, there are a total of 18 streams of public channel and user data, and data traffic between the RRU and the BBU may be calculated according to the following manner:

Time domain data traffic=quantity of beams(quantity of pieces of spatial multiplexing data)×sampling rate×(I bit width+Q bit width)/1000; and

SRS traffic=96(quantity of RBs)×12(quantity of subcarriers of each RB)×30 bit(I+Q bit width)×quantity of physical antennas/67 us.

Correspondingly, after receiving data that is obtained after antenna to beam mapping (Antenna to Beam Mapping) processing and sent by the RRU, the BBU performs Fourier transformation FFT processing and cyclic prefix CP removing processing on the data, to obtain frequency domain data, and the BBU processes the frequency domain data to obtain uplink data. Specifically, as shown in FIG. 5A and FIG. 5B, the BBU successively performs resource element demapping, multiple-input multiple-output equalizer, inverse discrete Fourier transform (Inverse Discrete Fourier Transform, “IDFT” for short), demodulation, and decoder on the frequency domain data, to obtain the uplink data.

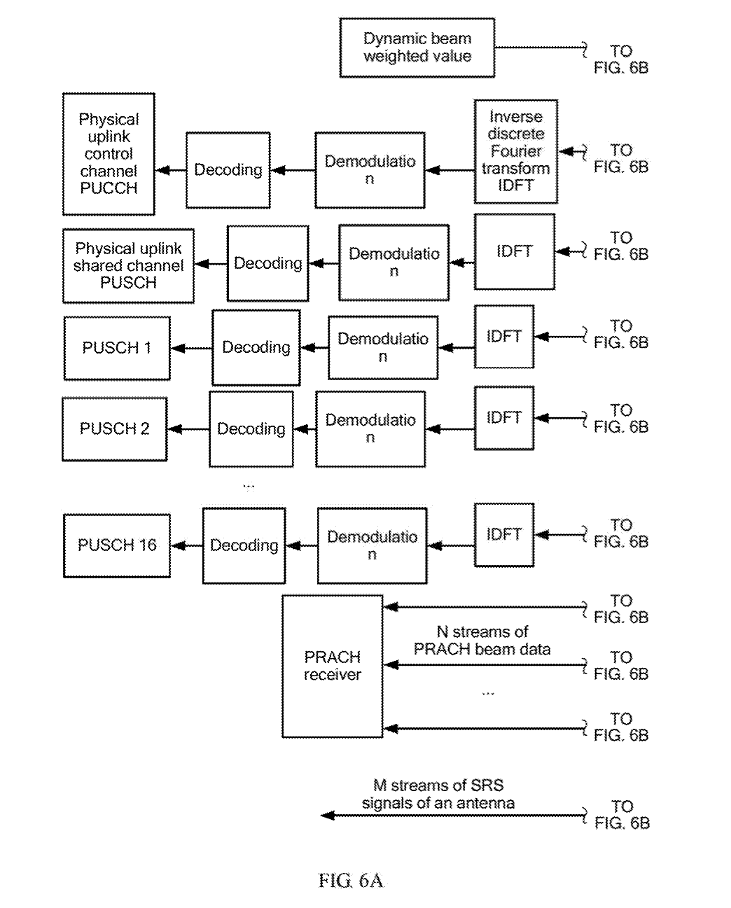

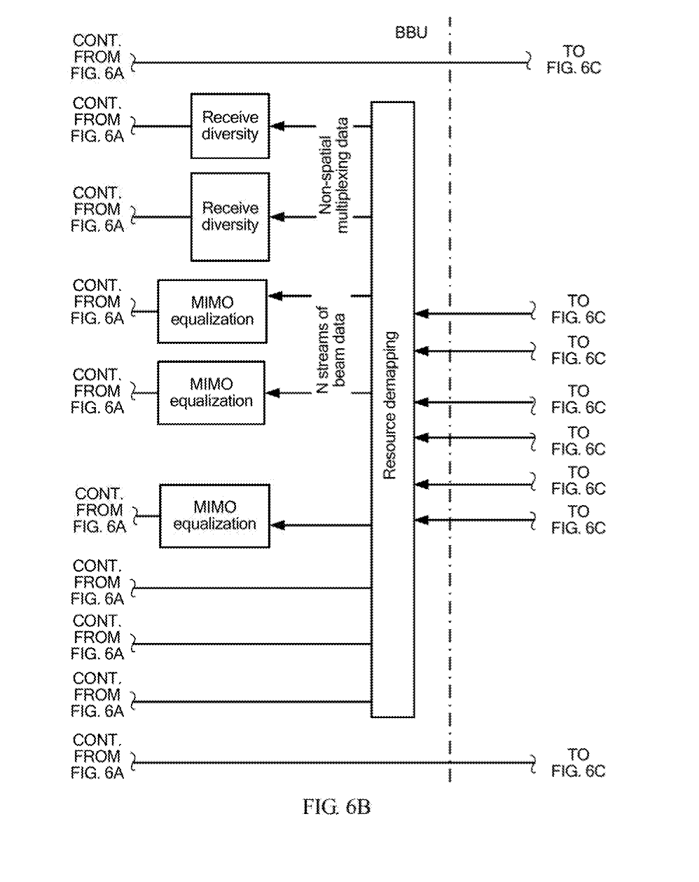

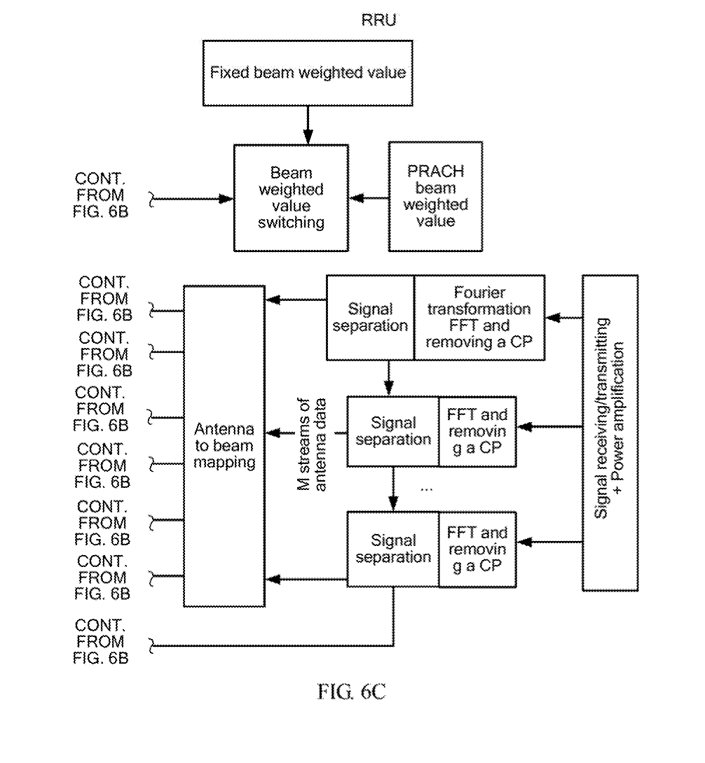

Optionally, in an example, as shown in FIG. 6A, FIG. 6B, and FIG. 6C, in an uplink, the RRU performs fast Fourier transformation FFT processing and cyclic prefix CP removing processing on an uplink signal, to obtain a frequency domain signal, and then separates the SRS and the data from the frequency domain signal.

Optionally, when receiving an uplink signal of the user equipment, the RRU may separate the SRS in a time domain, then performs FFT processing and processing of removing a CP on remaining data, to obtain the frequency domain data, then performs antenna to beam mapping processing on the frequency domain data, and sends mapping-processed data to the BBU.

Therefore, the data received by the BBU is data obtained after the antenna to beam mapping processing, and then the BBU successively performs resource element demapping, multiple-input multiple-output equalizer, IDFT, demodulation, and decoder on the received data obtained after the antenna to beam mapping processing, to obtain uplink data.

In this embodiment of the present invention, optionally, data on which the RRU performs the antenna to beam mapping processing includes non-spatial multiplexing data and spatial multiplexing data. The RRU may receive an uplink dynamic antenna weighted value sent by the BBU, performs antenna to beam mapping processing on the spatial multiplexing data according to the uplink dynamic antenna weighted value, and performs antenna to beam mapping processing on the non-spatial multiplexing data according to an uplink static antenna weighted value.

Optionally, the non-spatial multiplexing data includes public control channel data and user data, and the data may further include physical random access channel (Physical Random Access Channel, “PRACH” for short) data. For example, in FIG. 6A, FIG. 6B, and FIG. 6C, assuming that public control channel data and non-spatial multiplexing user data are single streams, spatial multiplexing user data is 16 streams, and a quantity of physical antennas is 64, after the RRU performs antenna to beam mapping processing, 64 streams of antenna data are converted into 16 streams of beam data, and then the RRU sends the 16 streams of beam data to the BBU.

Specifically, the 64 streams of antenna data include three types of data: non-spatial multiplexing public channel data and user data, PRACH data, and spatial multiplexing user data. Matrix architectures that are for antenna to beam mapping and of the three types of data are a same 64*16 matrix, and only uplink dynamic antenna weighted values (or referred to as “beam weighted values”) inside the matrix are different. From the perspective of a frequency domain, the three types of data may be identified, that is, antenna to beam mapping is performed on different data by using different beam weighted values. For example, antenna to beam mapping is performed on the spatial multiplexing user data by using a dynamic beam weighted value, antenna to beam mapping is performed on non-spatial multiplexing public channel and user data by using a static (fixed) beam weighted value, antenna to beam mapping is performed on the PRACH data by using a PRACH beam weighted value, and finally, beam data is transmitted to a BBU side.

In addition, the dynamic beam weighted value is generated in the BBU, and then is transmitted from the BBU to the RRU. The fixed beam weighted value and the PRACH beam weighted value are generated in the RRU, for example, the fixed beam weighted value and the PARACH beam weighted value may be pre-configured in the RRU.

At the BBU side, after resource element demapping processing is performed on the beam data, the non-spatial multiplexing public channel data and user data, the PRACH data, and the spatial multiplexing user data are separated and transmitted to respective receivers for corresponding processing.

In an uplink, data traffic between the RRU and the BBU may be calculated according to the following method:

Data traffic=J(quantity of ports(Port))×1200×30 bits(I+Q bit width)/67 us(symbol time):

SRS data traffic: 96(quantity of RBs)*12(quantity of subcarriers of each RB)*30 bit(I+Q bit width)*M(quantity of physical antennas)/67 us;

forming coefficient: J×25(resource block group(RBG))×M×30 bit (forming coefficient bit width); and

PRACH data traffic: 6(quantity of RBs)×12(quantity of subcarriers)×30 bit(I+Q bit width)×quantity of uplink PRACH streams/67 us.

In the data transmission method of this embodiment of the present invention, an RRU performs antenna to stream mapping processing in a downlink. The RRU performs antenna to beam mapping processing in an uplink, and therefore service stream data is transmitted between a BBU and the RRU. This can reduce data traffic between the BBU and the RRU, so as to reduce fronthaul data bandwidth between the BBU and the RRU.

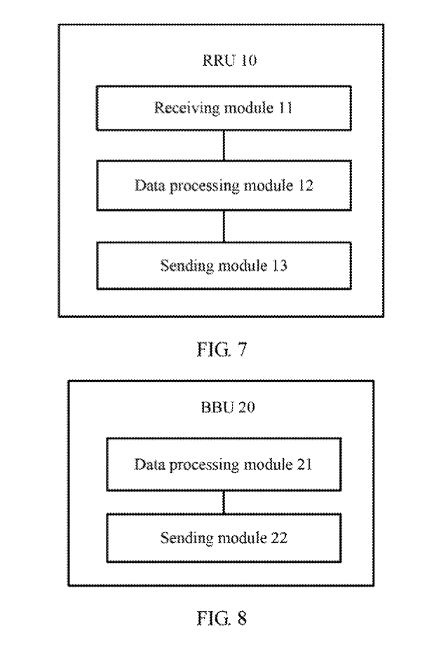

The foregoing describes in detail a data transmission method according to embodiments of the present invention with reference to FIG. 3 to FIG. 6A. FIG. 6B, and FIG. 6C, and the following describes in detail an RRU 10 according to the embodiments of the present invention with reference to FIG. 7 to FIG. 10.

FIG. 7 shows an RRU 10 according to an embodiment of the present invention, and the RRU 10 includes: a receiving module 11, configured to receive stream data sent by a BBU, where the stream data is obtained after the BBU performs resource mapping processing on to-be-transmitted downlink data; a data processing module 12, configured to perform stream to antenna mapping processing on the stream data; and a sending module 13, configured to send mapping-processed data to user equipment by using an antenna.

The RRU in this embodiment of the present invention completes stream to antenna mapping processing in a downlink, and therefore service stream data is transmitted between a BBU and the RRU. This can reduce data traffic between the BBU and the RRU, so as to reduce fronthaul data bandwidth between the BBU and the RRU.

Optionally, in this embodiment of the present invention, the data processing module 12 is further configured to: perform inverse fast Fourier transformation IFFT processing and cyclic prefix CP insertion processing on the mapping-processed data, to obtain downlink data; and the sending module 13 is specifically configured to send the downlink data to the user equipment by using the antenna.

Optionally, in this embodiment of the present invention, the receiving module 11 is further configured to receive a downlink dynamic antenna weighted value sent by the BBU; and the data processing module 12 is specifically configured to perform the stream to antenna mapping processing on the stream data according to the downlink dynamic antenna weighted value.

Optionally, in this embodiment of the present invention, the data processing module 12 is further configured to perform antenna to beam mapping processing on data of the user equipment; and the sending module 13 is configured to send mapping-processed data to the BBU.

Optionally, in this embodiment of the present invention, the receiving module 11 is specifically configured to receive, by using the antenna, an uplink signal sent by the user equipment, where the uplink signal includes the data and a sounding reference signal SRS; the data processing module 12 is further configured to separate the SRS and the data from the uplink signal; and the sending module 13 is further configured to send the SRS to the BBU.

Optionally, in this embodiment of the present invention, the data processing module 12 is specifically configured to: perform fast Fourier transformation FFT processing and cyclic prefix CP removing processing on the uplink signal, to obtain a frequency domain signal; and separate the SRS and the data from the frequency domain signal.

Optionally, in this embodiment of the present invention, the data includes non-spatial multiplexing data and spatial multiplexing data; the receiving module 11 is further configured to receive an uplink dynamic antenna weighted value sent by the BBU; the data processing module 12 is configured to perform antenna to stream mapping processing on the spatial multiplexing data according to the uplink dynamic antenna weighted value; and the data processing module 12 is further configured to perform antenna to stream mapping processing on the non-spatial multiplexing data according to an uplink static antenna weighted value.

It should be understood that the RRU 10 herein is embodied in a form of a functional module. Herein, the term “module” may refer to an application-specific integrated circuit (Application Specific Integrated Circuit, “ASIC” for short), an electronic circuit, a processor configured to execute one or more software or firmware programs (such as a shared processor, a dedicated processor, or a group processor), a memory, a merged logic circuit, and/or another proper component supporting the described functions. In an optional example, a person skilled in the art may understand that the RRU 10 may be configured to execute processes and/or steps executed by an RRU in the method 100 in the foregoing method embodiment. To avoid repetition, details are not described herein.

FIG. 8 shows a BBU 20 according to an embodiment of the present invention, and as shown in FIG. 8, the BBU 20 includes: a data processing module 21, configured to perform resource mapping processing on to-be-transmitted downlink data to obtain stream data; and a sending module 22, configured to send the stream data to an RRU, so that the RRU performs stream to antenna mapping processing on the stream data, and sends mapping-processed data to user equipment by using an antenna.

The BBU in this embodiment of the present invention sends stream data to an RRU in a downlink, and then the RRU completes stream to antenna mapping processing. This can reduce data traffic between the BBU and the RRU, so as to reduce fronthaul data bandwidth between the BBU and the RRU.

Optionally, in this embodiment of the present invention, the data processing module 21 is further configured to determine a downlink dynamic antenna weighted value; and the sending module 22 is further configured to send the downlink dynamic antenna weighted value to the RRU, so that the RRU performs the stream to antenna mapping processing on the stream data according to the downlink dynamic antenna weighted value.

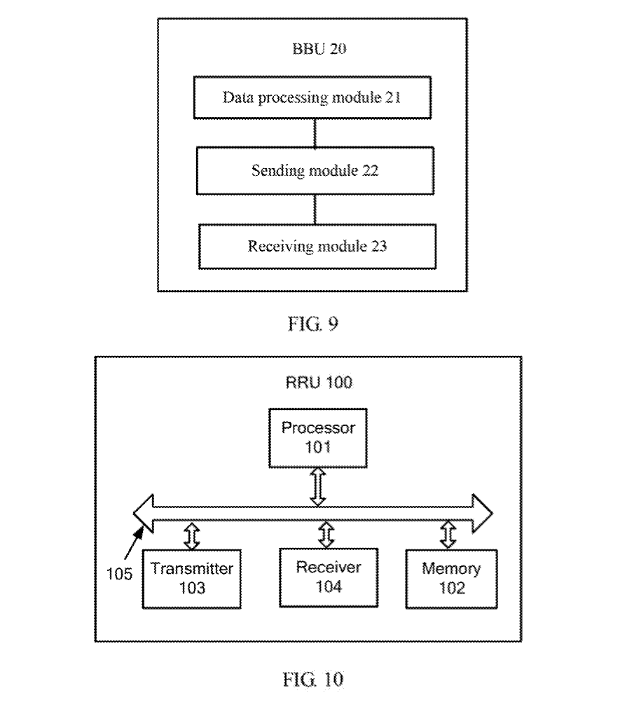

Optionally, in this embodiment of the present invention, as shown in FIG. 9, the BBU 20 further includes: a receiving module 23, configured to receive data sent by the RRU, where the data is obtained after the RRU performs antenna to beam mapping processing on data of the user equipment; and the data processing module 21 is configured to process the data to obtain uplink data.

Optionally, in this embodiment of the present invention, the receiving module 23 is further configured to: receive a sounding reference signal SRS sent by the RRU.

Optionally, in this embodiment of the present invention, the data processing module 21 is specifically configured to: obtain frequency domain data after performing Fourier transformation FFT processing and cyclic prefix CP removing processing on the data; and process the frequency domain data to obtain the uplink data.

Optionally, in this embodiment of the present invention, the data includes non-spatial multiplexing data and spatial multiplexing data; the data processing module 21 is further configured to determine an uplink dynamic antenna weighted value; and the sending module 22 is further configured to send the uplink dynamic antenna weighted value to the RRU, so that the RRU performs antenna to beam mapping processing on the spatial multiplexing data according to the uplink dynamic antenna weighted value.

It should be understood that the BBU 20 herein is embodied in a form of a functional module. Herein, the term “module” may refer to an application-specific integrated circuit (Application Specific Integrated Circuit, “ASIC” for short), an electronic circuit, a processor configured to execute one or more software or firmware programs (such as a shared processor, a dedicated processor, or a group processor), a memory, a merged logic circuit, and/or another proper component supporting the described functions. In an optional example, a person skilled in the art may understand that the BBU 20 may be configured to execute processes and/or steps executed by a BBU in the method 100 in the foregoing method embodiment. To avoid repetition, details are not described herein.

FIG. 10 shows an RRU 100 according to still another embodiment of the present invention. The RRU 100 includes a processor 101, a memory 102, a transmitter 103, a receiver 104, and a bus system 105. The processor 101, the memory 102, the transmitter 103, and the receiver 104 are connected by using the bus system 105. The memory 102 is configured to store an instruction, and the processor 101 is configured to execute the instruction stored by the memory 102, so that the RRU 100 executes steps executed by an RRU in the foregoing method 100. For example:

The receiver 104 is configured to receive stream data sent by a BBU, where the stream data is obtained after the BBU performs resource mapping processing on to-be-transmitted downlink; the processor 101 is configured to perform stream to antenna mapping processing on the stream data; and the transmitter 103 is configured to send mapping-processed data to user equipment by using an antenna.

The RRU in this embodiment of the present invention completes stream to antenna mapping processing in a downlink, and therefore service stream data is transmitted between a BBU and the RRU. This can reduce data traffic between the BBU and the RRU, so as to reduce fronthaul data bandwidth between the BBU and the RRU.

It should be understood that in this embodiment of the present invention, optionally, the processor 101 may be a central processing unit (Central Processing Unit, CPU for short), or the processor 101 may be another general purpose processor, a digital signal processor (Digital Signal Processing, DSP for short), an application-specific integrated circuit (Application Specific Integrated Circuit, ASIC for short), a field programmable gate array (Field-Programmable Gate Array, FPGA for short) or another programmable logic device, a discrete gate or transistor logic device, a discrete hardware component, or the like. The general purpose processor may be a microprocessor, or the processor may be any normal processor or the like.

Optionally, the processor 101 may also be a dedicated processor, and the dedicated processor may include at least one of a baseband processing chip, a radio frequency processing chip, or the like. Further, the dedicated processor may further include a chip with another dedicated processing function of a base station.

The memory 102 may include a read-only memory and a random access memory, and provides an instruction and data for the processor 101. A part of the memory 102 may further include a nonvolatile random access memory. For example, the memory 102 may further store information about a device type.

In addition to a data bus, the bus system 105 may further include a power bus, a control bus, a status signal bus, and the like. However, for clarity of description, various buses are marked as the bus system 105 in the figure.

In an implementation process, the steps in the foregoing method may be executed by using an integrated logic circuit of hardware in the processor 101 or an instruction in a software form. The steps of the method disclosed with reference to the embodiments of the present invention may be directly performed by a hardware processor, or may be performed by using a combination of hardware in the processor and a software module. The software module may be located in a mature storage medium in the field, such as a random access memory, a flash memory, a read-only memory, a programmable read-only memory, an electrically-erasable programmable memory, or a register. The storage medium is located in the memory 102. The processor 101 reads information from the memory 102, and completes the steps of the foregoing method in combination with the hardware. To avoid repetition, details are not described herein.

Optionally, in an embodiment, the processor 101 is further configured to: perform inverse fast Fourier transformation IFFT processing and cyclic prefix CP insertion processing on the mapping-processed data, to obtain downlink data; and the transmitter 103 is specifically configured to send the downlink data to the user equipment by using the antenna.

Optionally, in an embodiment, the receiver 104 is further configured to receive a downlink dynamic antenna weighted value sent by the BBU; and the processor 101 is specifically configured to perform the stream to antenna mapping processing on the stream data according to the downlink dynamic antenna weighted value.

Optionally, in an embodiment, the processor 101 is further configured to perform antenna to beam mapping processing on data of the user equipment; and the transmitter 103 is configured to send mapping-processed data to the BBU.

Optionally, in an embodiment, the receiver 104 is specifically configured to receive, by using the antenna, an uplink signal sent by the user equipment, where the uplink signal includes the data and a sounding reference signal SRS; the processor 101 is further configured to separate the SRS and the data from the uplink signal; and the transmitter 103 is further configured to send the SRS to the BBU.

Optionally, in an embodiment, the processor 101 is specifically configured to: perform fast Fourier transformation FFT processing and cyclic prefix CP removing processing on the uplink signal, to obtain a frequency domain signal; and separate the SRS and the data from the frequency domain signal.

Optionally, in an embodiment, the data includes non-spatial multiplexing data and spatial multiplexing data; the receiver 104 is further configured to receive an uplink dynamic antenna weighted value sent by the BBU; the processor 101 is configured to perform antenna to beam mapping processing on the spatial multiplexing data according to the uplink dynamic antenna weighted value; and the processor 101 is further configured to perform antenna to beam mapping processing on the non-spatial multiplexing data according to an uplink static antenna weighted value.

The RRU in this embodiment of the present invention performs antenna to stream mapping processing in a downlink, and performs antenna to beam mapping processing in an uplink, and therefore service stream data is transmitted between a BBU and the RRU. This can reduce data traffic between the BBU and the RRU, so as to reduce fronthaul data bandwidth between the BBU and the RRU.

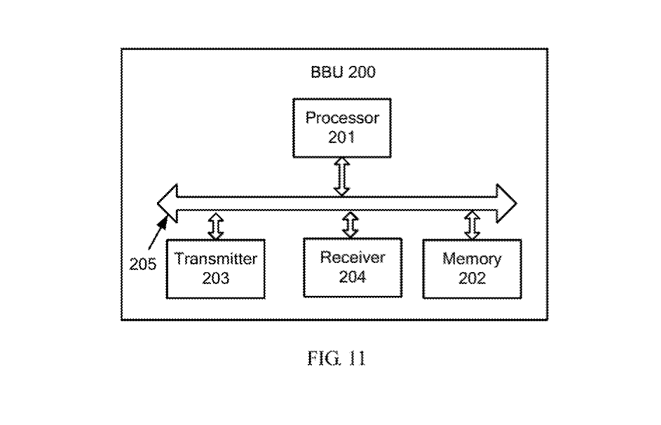

FIG. 11 shows a BBU 200 according to still another embodiment of the present invention. The BBU 200 includes a processor 201, a memory 202, a transmitter 203, a receiver 204, and a bus system 205. The processor 201, the memory 202, the transmitter 203, and the receiver 204 are connected by using the bus system 205. The memory 202 is configured to store an instruction, and the processor 201 is configured to execute the instruction stored by the memory 202, so that the BBU 200 executes steps executed by a BBU in the foregoing method 100. For example:

The processor 201 is configured to perform resource mapping processing on to-be-transmitted downlink data to obtain stream data, and the transmitter 203 is configured to send the stream data to an RRU, so that the RRU performs stream to antenna mapping processing on the stream data, and sends mapping-processed data to user equipment by using an antenna.

The BBU in this embodiment of the present invention sends stream data to an RRU in a downlink, and then the RRU completes stream to antenna mapping processing. This can reduce data traffic between the BBU and the RRU, so as to reduce fronthaul data bandwidth between the BBU and the RRU.

It should be understood that in this embodiment of the present invention, optionally, the processor 201 may be a central processing unit (Central Processing Unit, CPU for short), or the processor 201 may be another general purpose processor, a digital signal processor (Digital Signal Processing, DSP for short), an application-specific integrated circuit (Application Specific Integrated Circuit, ASIC for short), a field programmable gate array (Field-Programmable Gate Array, FPGA for short) or another programmable logic device, a discrete gate or transistor logic device, a discrete hardware component, or the like. The general purpose processor may be a microprocessor, or the processor may be any normal processor or the like.

Optionally, the processor 201 may also be a dedicated processor, and the dedicated processor may include at least one of a baseband processing chip, a radio frequency processing chip, or the like. Further, the dedicated processor may further include a chip with another dedicated processing function of a base station.

The memory 202 may include a read-only memory and a random access memory, and provides an instruction and data for the processor 201. A part of the memory 202 may further include a nonvolatile random access memory. For example, the memory 202 may further store information about a device type.

In addition to a data bus, the bus system 205 may further include a power bus, a control bus, a status signal bus, and the like. However, for clarity of description, various buses are marked as the bus system 205 in the figure.

In an implementation process, the steps in the foregoing method may be executed by using an integrated logic circuit of hardware in the processor 201 or an instruction in a software form. The steps of the method disclosed with reference to the embodiments of the present invention may be directly performed by a hardware processor, or may be performed by using a combination of hardware in the processor and a software module. The software module may be located in a mature storage medium in the field, such as a random access memory, a flash memory, a read-only memory, a programmable read-only memory, an electrically-erasable programmable memory, or a register. The storage medium is located in the memory 202. The processor 201 reads information from the memory 202, and completes the steps of the foregoing method in combination with the hardware. To avoid repetition, details are not described herein.

Optionally, the processor 201 is further configured to determine a downlink dynamic antenna weighted value; and the transmitter 203 is further configured to send the downlink dynamic antenna weighted value to the RRU, so that the RRU performs the stream to antenna mapping processing on the stream data according to the downlink dynamic antenna weighted value.

Optionally, in an embodiment, the receiver 204 is configured to receive data sent by the RRU, where the data is obtained after the RRU performs antenna to beam mapping processing on data of the user equipment; and the processor 201 is configured to process the data to obtain uplink data.

Optionally, in an embodiment, the receiver 204 is further configured to receive a sounding reference signal SRS sent by the RRU.

Optionally, in an embodiment, the processor 201 is specifically configured to: obtain frequency domain data after performing Fourier transformation FFT processing and cyclic prefix CP removing processing on the data; and process the frequency domain data to obtain the uplink data.

Optionally, in an embodiment, the data includes non-spatial multiplexing data and spatial multiplexing data; the processor 201 is further configured to determine an uplink dynamic antenna weighted value; and the transmitter 203 is further configured to send the uplink dynamic antenna weighted value to the RRU, so that the RRU performs antenna to beam mapping processing on the spatial multiplexing data according to the uplink dynamic antenna weighted value.

The BBU in this embodiment of the present invention sends stream data to an RRU in a downlink, and then the RRU completes stream to antenna mapping processing. In an uplink, the BBU receives beam data obtained after the RRU performs antenna to beam mapping processing. This can reduce data traffic between the BBU and the RRU, so as to reduce fronthaul data bandwidth between the BBU and the RRU.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described.

In the several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A data transmission method, wherein the method is applied to a base station, the base station comprises a baseband unit (BBU) and a remote radio unit (RRU), and the method comprises:
receiving, by the RRU, stream data sent by the BBU, wherein the stream data is obtained after the BBU performs resource mapping processing on to-be-transmitted downlink data;
performing, by the RRU, stream to antenna mapping processing on the stream data; and
sending, by the RRU, mapping-processed data to user equipment by using an antenna.

2. The method according to claim 1, wherein the sending, by the RRU, mapping-processed data to user equipment by using an antenna comprises:
performing, by the RRU, inverse fast Fourier transformation (IFFT) processing and cyclic prefix (CP) insertion processing on the mapping-processed data, to obtain downlink data; and
sending, by the RRU, the downlink data to the user equipment by using the antenna.

3. The method according to claim 1, wherein the method further comprises:
receiving, by the RRU, a downlink dynamic antenna weighted value sent by the BBU; and
the performing, by the RRU, stream to antenna mapping processing on the stream data comprises:
performing, by the RRU, the stream to antenna mapping processing on the stream data according to the downlink dynamic antenna weighted value.

4. The method according to claim 1, wherein the method further comprises:
performing, by the RRU, antenna to beam mapping processing on data of the user equipment; and
sending, by the RRU, mapping-processed data to the BBU.

5. The method according to claim 4, wherein the method further comprises:
receiving, by the RRU by using the antenna, an uplink signal sent by the user equipment, wherein the uplink signal comprises the data and a sounding reference signal (SRS);
separating, by the RRU, the SRS and the data from the uplink signal; and
sending, by the RRU, the SRS to the BBU.

6. The method according to claim 4, wherein the separating, by the RRU, the SRS and the data from the uplink signal comprises:
performing, by the RRU, fast Fourier transformation FFT processing and cyclic prefix (CP) removing processing on the uplink signal, to obtain a frequency domain signal; and
separating, by the RRU, the SRS and the data from the frequency domain signal.

7. The method according to claim 6, wherein the data comprises non-spatial multiplexing data and spatial multiplexing data; and
the performing, by the RRU, antenna to beam mapping processing on data of the user equipment comprises:
receiving an uplink dynamic antenna weighted value sent by the BBU;
performing antenna to beam mapping processing on the spatial multiplexing data according to the uplink dynamic antenna weighted value; and
performing antenna to beam mapping processing on the non-spatial multiplexing data according to an uplink static antenna weighted value.

8. A remote radio unit (RRU), wherein the RRU is applied to a base station, the base station comprises a baseband unit (BBU) and the RRU, and the RRU comprises:
a memory storing instructions; and
a computer device to execute the instructions to configure the computer device to implement:
a receiving module, configured to receive stream data sent by the BBU, wherein the stream data is obtained after the BBU performs resource mapping processing on to-be-transmitted downlink data;
a data processing module, configured to perform stream to antenna mapping processing on the stream data; and
a sending module, configured to send mapping-processed data to user equipment by using an antenna.

9. The RRU according to claim 8, wherein the data processing module is further configured to:
perform inverse fast Fourier transformation (IFFT) processing and cyclic prefix (CP) insertion processing on the mapping-processed data, to obtain downlink data; and
the sending module is specifically configured to:
send the downlink data to the user equipment by using the antenna.

10. The RRU according to claim 8, wherein the receiving module is further configured to:
receive a downlink dynamic antenna weighted value sent by the BBU; and
the data processing module is specifically configured to:
perform the stream to antenna mapping processing on the stream data according to the downlink dynamic antenna weighted value.

11. The RRU according to claim 8, wherein the data processing module is further configured to:
perform antenna to beam mapping processing on data of the user equipment; and
the sending module is configured to:
send mapping-processed data to the BBU.

12. The RRU according to claim 11, wherein the receiving module is specifically configured to:
receive, by using the antenna, an uplink signal sent by the user equipment, wherein the uplink signal comprises the data and a sounding reference signal (SRS);
the data processing module is further configured to:
separate the SRS and the data from the uplink signal; and
the sending module is further configured to:
send the SRS to the BBU.

13. The RRU according to claim 11, wherein the data processing module is specifically configured to:
perform fast Fourier transformation (FFT) processing and cyclic prefix (CP) removing processing on the uplink signal, to obtain a frequency domain signal; and
separate the SRS and the data from the frequency domain signal.

14. The RRU according to claim 13, wherein the data comprises non-spatial multiplexing data and spatial multiplexing data;
the receiving module is further configured to receive an uplink dynamic antenna weighted value sent by the BBU;
the data processing module is configured to perform antenna to beam mapping processing on the spatial multiplexing data according to the uplink dynamic antenna weighted value; and
the data processing module is further configured to perform antenna to beam mapping processing on the non-spatial multiplexing data according to an uplink static antenna weighted value.

15. A baseband unit (BBU), wherein the BBU is applied to a base station, the base station comprises the BBU and a remote radio unit (RRU), and the BBU comprises:
a memory storing instructions; and
a computer device to execute the instructions to configure the computer device to implement:
a data processing module, configured to perform resource mapping processing on to-be-transmitted downlink data to obtain stream data; and
a sending module, configured to send the stream data to the RRU, so that the RRU performs stream to antenna mapping processing on the stream data, and sends mapping-processed data to user equipment by using an antenna.

16. The BBU according to claim 15, wherein the data processing module is further configured to:
determine a downlink dynamic antenna weighted value; and
the sending module is further configured to:
send the downlink dynamic antenna weighted value to the RRU, so that the RRU performs the stream to antenna mapping processing on the stream data according to the downlink dynamic antenna weighted value.

17. The BBU according to claim 15, wherein the BBU further comprises:
a receiving module, configured to receive data sent by the RRU, wherein the data is obtained after the RRU performs antenna to beam mapping processing on data of the user equipment; and
the data processing module is configured to:
process the data to obtain uplink data.

18. The BBU according to claim 17, wherein the receiving module is further configured to:
receive a sounding reference signal (SRS) sent by the RRU.

19. The BBU according to claim 17, wherein the data processing module is specifically configured to:
obtain frequency domain data after performing Fourier transformation (FFT) processing and cyclic prefix (CP) removing processing on the data; and
process the frequency domain data to obtain the uplink data.

20. The BBU according to claim 17, wherein the data comprises non-spatial multiplexing data and spatial multiplexing data;
the data processing module is further configured to determine an uplink dynamic antenna weighted value; and
the sending module is further configured to send the uplink dynamic antenna weighted value to the RRU, so that the RRU performs antenna to beam mapping processing on the spatial multiplexing data according to the uplink dynamic antenna weighted value.
